(19) United States
(12) Patent Application Publication
(10) Pub. No.: US 2026/0187009 A1
(43) Pub. Date: Jul. 2, 2026

(54) POWER BANK HAVING FUNCTION OF DOCKING STATION

(71) Applicant: Tianjin Synergy Groups Co., Ltd., Tianjin (CN)

(72) Inventors: Peng CHEN, Tianjin (CN); Senlin ZHANG, Tianjin (CN)

(73) Assignee: Tianjin Synergy Groups Co., Ltd., Tianjin (CN)

(21) Appl. No.: 19/131,489

(22) PCT Filed: Sep. 7, 2023
(86) PCT No.: PCT/CN2023/117361

§ 371 Date: May 20, 2025

(30) Foreign Application Priority Data
Feb. 9, 2023 (CN) 202320201650.7

(51) Int. Cl. G06F 13/40; G06F 1/26; G06F 3/14; H04M 1/04

(52) U.S. Cl. CPC G06F 13/4081; G06F 1/266; G06F 3/14; G06F 2213/0042; H04M 1/04

(57) ABSTRACT

A power bank with a docking station function includes a video conversion unit, a data conversion unit, a controller, and an analog switch unit. The controller is electrically connected to the analog switch unit. The analog switch unit is electrically connected to the data conversion unit. The video conversion unit is electrically connected to a Type-C main interface. The video conversion unit is electrically connected to the data conversion unit. The analog switch unit is electrically connected to a USB interface. The controller controls an S pin of the analog switch unit to be at a low level or a high level through a PA6 pin of the controller so that the USB interface has a data transmission function or a fast charging function.

This application claims priority to Chinese Patent Application No. 202320201650.7 filed with the China National Intellectual Property Administration (CNIPA) on Feb. 9, 2023, the disclosure of which is incorporated herein by reference in its entirety.

### TECHNICAL FIELD

This application relates to the field of power bank technologies, for example, a power bank with a docking station function.

### BACKGROUND

With the rapid development of the economy and the continuous improvement of people's living standards, portable electronic products such as mobile phones, digital cameras, camcorders, and personal digital assistants (PDAs) are becoming more and more common. The increasing number of such portable digital devices has correspondingly resulted in an increased demand for power banks. Typically, a power bank has only a charging interface for providing a charging function, not satisfying the actual requirements for data transmission of laptops. There is a demand for an additional data transmission cable. Currently, power banks have evolved from standard 5V charging to fast charging.

The widespread application of Type-C interfaces makes the interfaces of smart portable devices unified and makes smart portable devices thinner. A conventional laptop generally uses, for example, a dedicated charging interface, a Type-A interface, an HDMI interface, or an RJ45 interface. However, as more and more laptops and smartphones use Type-C interfaces that integrate charging, data transmission, and audio/video transmission, interfaces for devices such as monitors and projectors are still mostly HDMI. The demand for HUB docking stations is anticipated to continue in the coming years.

The interface of a smartphone has been simplified to just a Type-C interface. A laptop also uses a Type-C interface. In daily use, a power bank with a fast charging function is required to charge a phone, a laptop, or other devices for extended power. In scenarios such as USB flash drive data storage and screen casting, a HUB docking station is required. In other words, when traveling, it is necessary to carry both a power bank and a docking station, causing inconvenience.

### SUMMARY

This application provides a power bank with a docking station function. The power bank with a docking station function includes a video conversion unit, a data conversion unit, a controller, and an analog switch unit. The controller is electrically connected to the analog switch unit. The analog switch unit is electrically connected to the data conversion unit. The video conversion unit is electrically connected to a Type-C main interface. The video conversion unit is electrically connected to the data conversion unit. The analog switch unit is electrically connected to a USB interface. The controller controls an S pin of the analog switch unit to be at a low level or a high level through a PA6 pin of the controller so that the USB interface has a data transmission function or a fast charging function.

### BRIEF DESCRIPTION OF DRAWINGS

The drawings are used for providing a further understanding of this application and constitute a part of the description. The drawings are intended to explain this application in conjunction with embodiments of this application and not to limit this application.

FIG. 1 is a diagram illustrating the structure of a power bank with a docking station function according to an embodiment of this application.

FIG. 2 is a wiring diagram of a data conversion unit of a power bank with a docking station function according to an embodiment of this application.

FIG. 3 is a wiring diagram of a video conversion unit of a power bank with a docking station function according to an embodiment of this application.

FIG. 4 is a wiring diagram of a Type-C main interface of a power bank with a docking station function according to an embodiment of this application.

FIG. 5 is a wiring diagram of an analog switch unit of a power bank with a docking station function according to an embodiment of this application.

FIG. 6 is a wiring diagram of a controller of a power bank with a docking station function according to an embodiment of this application.

### DETAILED DESCRIPTION

Embodiments of this application are described clearly and completely in conjunction with drawings in the embodiments of this application. Apparently, the embodiments described are part, not all, of the embodiments of this application. Based on embodiments of this application, all other embodiments obtained by those of ordinary skill in the art without creative work are within the scope of this application.

It is to be noted that when a component is described as being “secured to” the other component, the component may be directly on the other component, or an intervening component may exist; when a component is considered as being “connected to” the other component, the component may be directly connected to the other component, or an intervening component may exist; and when a component is described as being “disposed on” the other component, the component may be directly disposed on the other component, or an intervening component may exist. The terms such as “vertical”, “horizontal”, “left”, and “right” used herein are for illustrative purposes.

Unless otherwise defined, all technical and scientific terms used herein have the same meanings as those commonly understood by those skilled in the art to which this application pertains. The terms used in the specification of this application are intended to describe embodiments of this application and not to limit this application. The term “and/or” used herein includes any or all combinations of one or more relevant items listed.

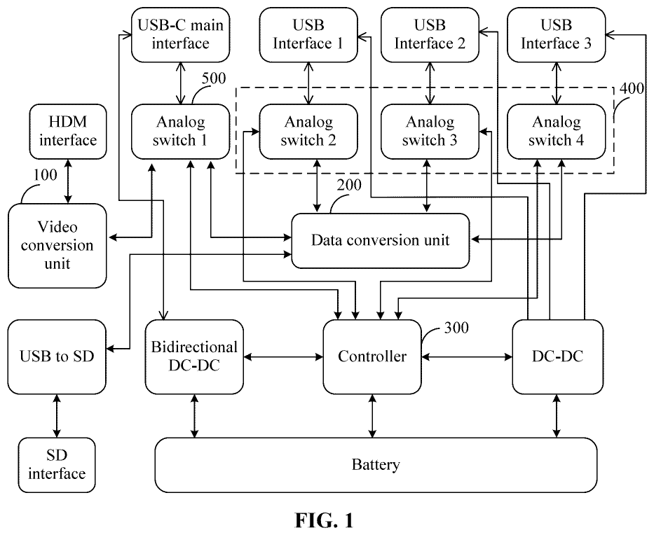

As shown in FIG. 1, an embodiment of this application provides a power bank with a docking station function. The power bank with a docking station function includes a video conversion unit 100, a data conversion unit 200, a controller 300, and an analog switch unit 400. The controller is electrically connected to the analog switch unit. The analog switch unit is electrically connected to the data conversion unit. The video conversion unit is electrically connected to a Type-C main interface. The video conversion unit is electrically connected to the data conversion unit. The analog switch unit is electrically connected to a USB interface. The controller controls an S pin of the analog switch unit to be at a low level or a high level through a PA6 pin of the controller so that the USB interface has a data transmission function or a fast charging function. During use, when a USB-C main interface is connected to a computer, the main controller and the computer communicate with each other through a configuration channel (CC) line. First, the two parties negotiate the Power Delivery (PD) power supply requirements. Upon completion of the negotiation, the controller controls the bidirectional direct current-direct current (DC-DC) to convert a battery voltage into a voltage required by the computer to charge the computer. Then the controller reports to the computer that the data expansion and video transmission functions are supported. Then the computer is connected to a data expansion chip through one of the USB 2.0 or USB 3.0 signal lines. After the connection succeeds, the data expansion chip extends the USB data to other USB interfaces and a USB-to-Secure Digital (SD) chip. At this time, other interfaces have a USB data transmission function. The other set of signals of USB 3.0 is connected to a Display Port (DP)-to-High Definition Multimedia Interface (HDMI) chip. Thus, a DP signal of a laptop is converted to a HDMI signal and then outputted.

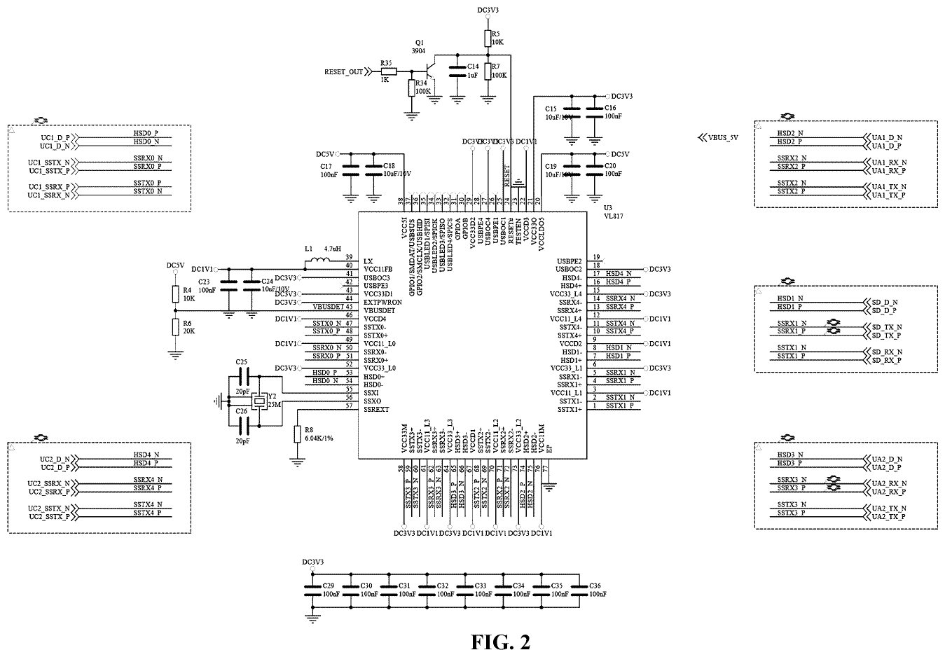

As shown in FIG. 2, in this embodiment, further, the data conversion unit is configured to expand a USB data signal from the computer into at least one USB data signal, an LNAP pin and an LNAN pin of the data conversion unit are connected to a DRX0P pin and a DRX0N pin of the video conversion unit, an LNBP pin and an LNBN pin of the data conversion unit are connected to a DRX1P pin and a DRX1N pin of the video conversion unit, an LNCP pin and an LNCN pin of the data conversion unit are connected to a DRX2P pin and a DRX2N pin of the video conversion unit, an LNDP pin and an LNDN pin of the data conversion unit are connected to a DRX3P pin and a DRX3N pin of the video conversion unit, and the chip model of the data conversion unit is set to VL817. VL817 offers 2-port and 4-port configurations. VL817 features an integrated regulator, a new low-power design, and comprehensive USB charging support. VL817 has a flexible firmware architecture. VL817 provides a customizable function framework, and supports field updates. Various parameters, including Tx equalization settings and general-purpose input/output (GPIO) behavior, can be altered by the firmware. Optionally, the configurable USB charging controller is provided for charging various devices, such as smartphones and tablets.

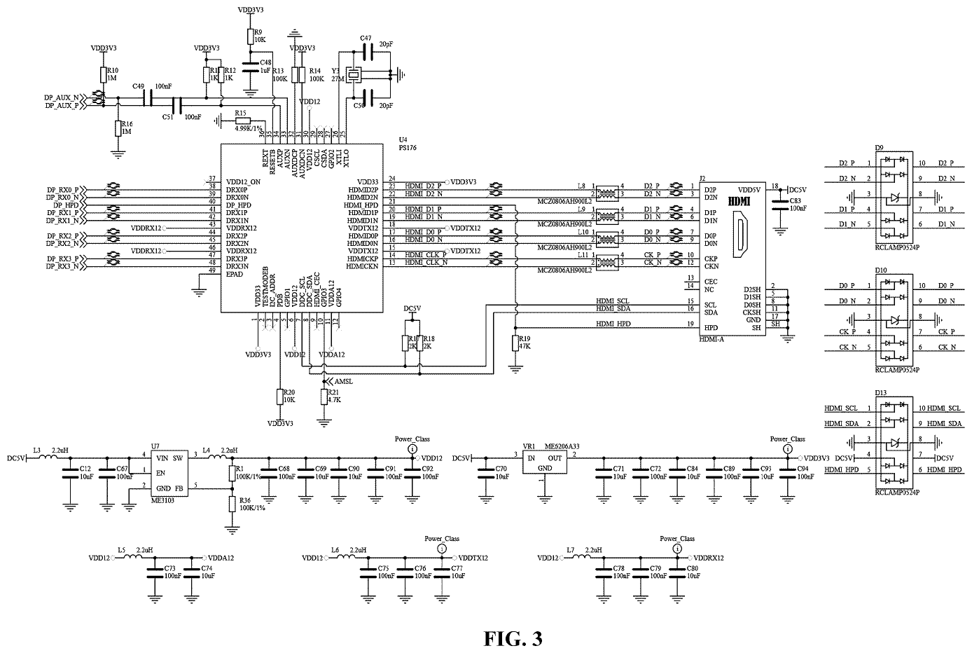

As shown in FIG. 3, in this embodiment, further, the video conversion unit is configured to convert a DP signal from the computer into an HDMI signal; an HDMID2P pin, an HDMID2N pin, an HDMID1P pin, an HDMID1N pin, an HDMID0P pin, and an HDMID0N pin of the video conversion unit are connected to a D2P pin, a D2N pin, a D1P pin, a D1N pin, a D0P pin, and a D0N pin of an HDMI respectively; and the chip model of the video conversion unit is set to PS176. After a USB-C receiving device is connected to such a signal converter, PS176 has the function of supporting DisplayPort Alt Mode and can receive all Thunderbolt 3 image signals. PS176 (which can be used for programming firmware updates) is also highly suitable for use in a USB-C expansion dock. An HDMI signal output through PS176 is compatible with a computer monitor and a 4K television. PS176 supports a maximum transmission rate of 6 Gbit/s for HDMI 2.0a and is compatible with downstream receiver repeaters that support HDCP 1.4 and HDCP 2.2. In addition, the PS176 integrates a microcontroller and supports an external SPI FLASH for custom applications. PS176 provides support for a state and control data channel (SCDC channel) and is used for extended display identification data (EDID) reading and point-to-point dynamic data exchange between the source and the sink. PS176 can detect a digital pre-distortion (DPD) receiver device through a HUB. It can be used as an HDMI_HPD input terminal and a DP HPD output terminal. These two variations mainly depend on the firmware configuration of the PS176 during operation. After power is applied, DP_HPD is a low frequency signal, and the signal transitions to high frequency once PS176 enters the signal conversion mode.

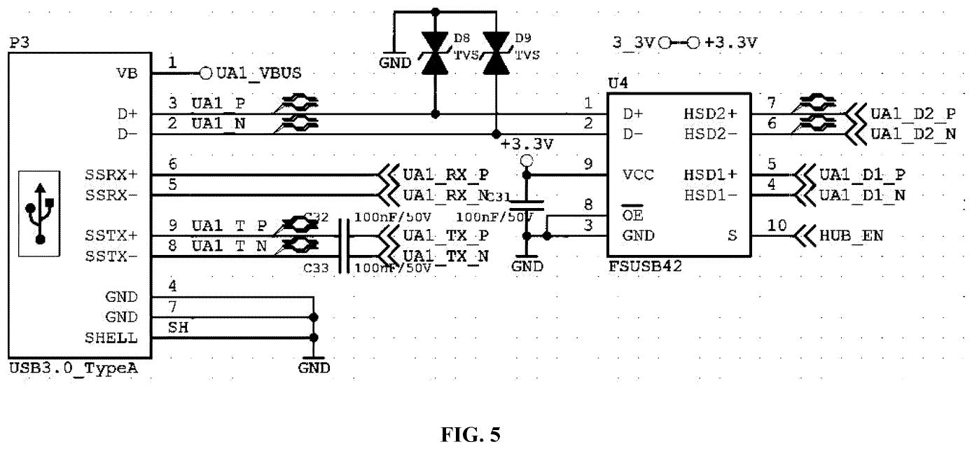

As shown in FIG. 5, in this embodiment, further, the S pin of the analog switch unit is connected to the PA6 pin of the controller through a HUB_EN terminal, the controller controls the S pin to be at the low level, a D+ pin and a D− pin of the analog switch unit are connected to an HSD1+ pin and an HSD1− pin, an HSD1+ pin and an HSD1− pin of the analog switch unit are connected to a D+ pin and a D− pin of the data conversion unit respectively through a UA1_D1_P signal terminal and a UA1_D1_N signal terminal, the USB interface has the data transmission function, and the chip model of the analog switch unit is set to FSUSB42. FSUSB42 has the advantages of low power consumption and dual interfaces, is compatible with USB 2.0, and features a 3.7 pF ultra-low capacitance, thereby reducing the interference of signal distortion.

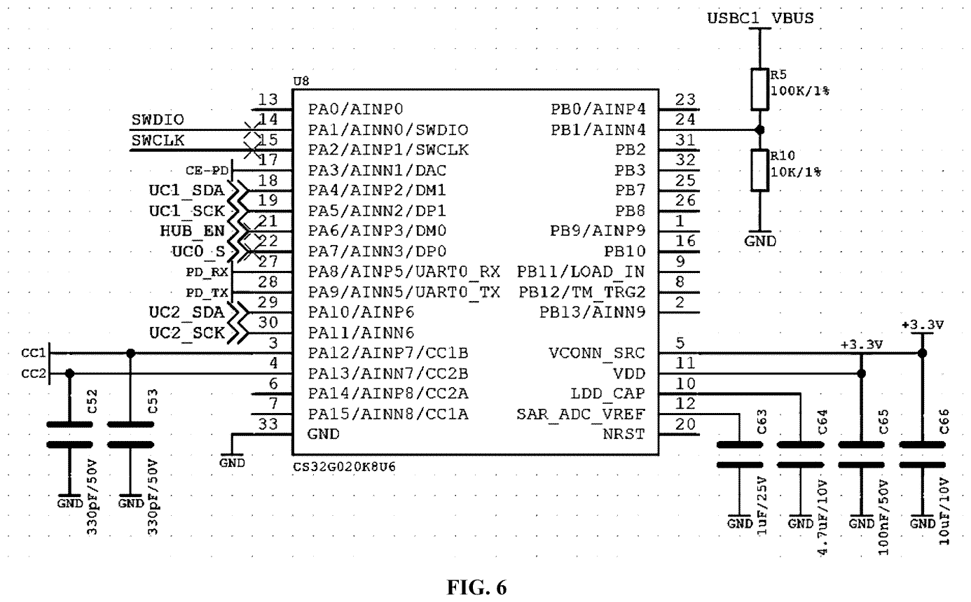

As shown in FIG. 6, in this embodiment, further, the controller controls the S pin of the analog switch unit to be at the high level, a D+ pin and a D− pin of the analog switch unit are connected to an HSD2+ pin and an HSD2− pin, the D+ pin and the D− pin of the analog switch unit are connected to a D+ pin and a D− pin of a fast charging chip respectively through a UA1_P signal terminal and a UA1_N signal terminal, and the USB interface has the fast charging function.

In this embodiment, further, the chip model of the controller is set to CS32G020K8U.

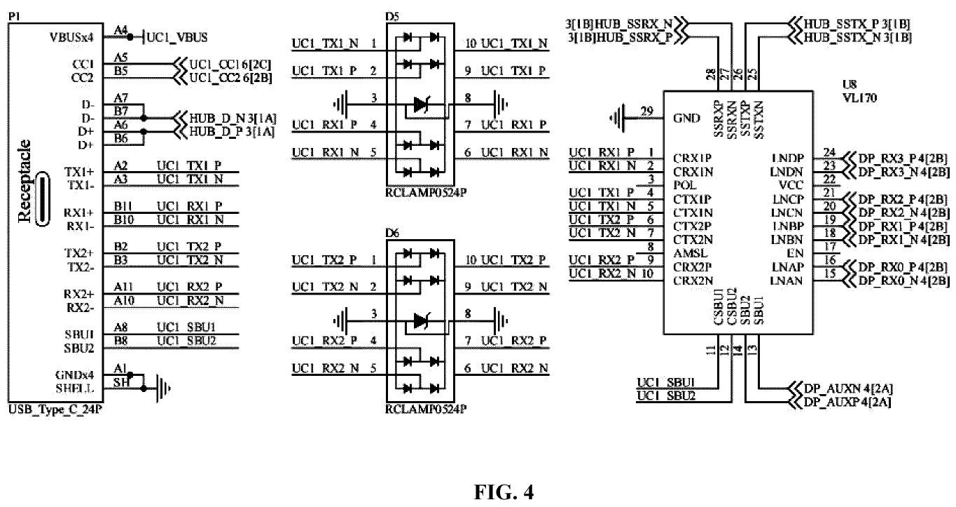

As shown in FIG. 4, in this embodiment, further, an HSD0− pin and an HSD0+ pin of the data conversion unit are connected to a D− pin and a D+ pin of the Type-C main interface respectively through a HUB_D_N terminal and a HUB_D_P terminal, and the chip model of the Type-C main interface is set to VL170.

Referring to FIG. 1, the reference numeral of the analog switch 1 is 500, and the analog switch 1 may be the chip VL170 of the Type-C main interface.

Referring to FIG. 1, the video conversion unit 100 may also be denoted as a DP-to-HDMI module, and the data conversion unit 200 may also be denoted as a data expansion chip HUB module.

The working process of embodiments of this application is as follows: During use, when the USB-C main interface is connected to the computer, the main controller and the computer communicate with each other through the configuration channel (CC) line. First, the two parties negotiate the PD power supply requirements. Upon completion of the negotiation, the controller controls the bidirectional direct current-direct current (DC-DC) to convert the battery voltage into the voltage required by the computer to charge the computer. Next, the controller reports to the computer that the data expansion and video transmission functions are supported. Then the computer is connected to the data expansion chip through one of the USB 2.0 or USB 3.0 signal lines. After the connection succeeds, the data expansion chip extends the USB data to other USB interfaces and the USB-to-Secure Digital (SD) chip. At this time, other interfaces have the USB data transmission function. In the data transmission process, there are mainly two sets of differential signals, TX/RX. CC1 and CC2 are the two key pins used to detect the connection. The other set of signals of USB 3.0 is connected to the Display Port (DP)-to-High Definition Multimedia Interface (HDMI) chip. Thus, the DP signal of the laptop is converted to the HDMI signal and then the HDMI signal is outputted.

In embodiments of this application, the capacity or the type of a battery is not limited. The battery may be a rechargeable lithium battery. The lithium battery may be a phosphoric acid or polymer lithium battery, and so on. The USB Type-C docking station is mainly used for function expansion of the Type-C interface and can conveniently implement applications such as a USB 3.0 interface, a DP/Video Graphics Array (VGA)/HDMI display interface, and a Type-C charging interface, facilitating charging and use. The HUB function of the power bank is to expand the single output port of the laptop into multiple versatile ports. The HUB function of the power bank not only enables data transfer but also supports video output, with a maximum supported resolution of 4K. On the other hand, it makes more convenient for Ultrabook to cast screens during PowerPoint (PPT) presentations and eliminates the need to carry an additional adapter for such scenarios. Thus, the multi-purpose feature is achieved. The HUB function can be enabled simply under the control of the controller. After the HUB function mode is enabled, in addition to expanding the HDMI screen switching function, the USB interface no longer supports charging and, instead, functions as a data transmission interface, allowing connections to peripherals such as USB flash drives, mice, and keyboards. In addition to the USB interface, a Type-C interface and an HDMI interface are also available. The Type-C interface is primarily designed to meet the needs of ultrabook users for Type-C interface expansion while the HDMI interface facilitates screen expansion.

In terms of switching between the data transmission function and the fast charging function, when the controller controls the S pin of the analog switch chip to be at the low level through the PA6 pin, the analog switch chip connects the D+ pin and the D− pin to the HSD1+ pin and the HSD1− pin, and the D+ pin and the D− pin of the USB interface are connected to the D+ pin and the D− pin of the HUB chip, and the interface has the data transmission function; and when the controller controls the S pin of the analog switch chip to be at the high level through the PA6 pin, the analog switch chip connects the D+ pin and the D− pin to the HSD2+ pin and the HSD2− pin, and the D+ pin and the D− pin of the USB interface are connected to the D+ pin and the D− pin of the fast charging chip, and the interface has the fast charging function.

Embodiments of this application have the following features: Compared with a conventional power bank, in embodiments of this application, the data and video conversion chip is added to enable the power bank to have data transmission and video transmission functions; and the analog switch chip is added to enable the USB interface to serve as both a data transmission interface and a fast charging interface.

What is claimed is:

1. A power bank with a docking station function, comprising a video conversion unit, a data conversion unit, a controller, and an analog switch unit, wherein the controller is electrically connected to the analog switch unit, the analog switch unit is electrically connected to the data conversion unit, the video conversion unit is electrically connected to a Type-C main interface, the video conversion unit is electrically connected to the data conversion unit, the analog switch unit is electrically connected to a universal serial bus (USB) interface, and the controller controls an S pin of the analog switch unit to be at a low level or a high level through a PA6 pin of the controller so that the USB interface has a data transmission function or a fast charging function.

2. The power bank with a docking station function according to claim 1, wherein the data conversion unit is configured to expand a USB data signal from a computer into at least one USB data signal, an LNAP pin and an LNAN pin of the data conversion unit are connected to a DRX0P pin and a DRX0N pin of the video conversion unit, an LNBP pin and an LNBN pin of the data conversion unit are connected to a DRX1P pin and a DRX1N pin of the video conversion unit, an LNCP pin and an LNCN pin of the data conversion unit are connected to a DRX2P pin and a DRX2N pin of the video conversion unit, and an LNDP pin and an LNDN pin of the data conversion unit are connected to a DRX3P pin and a DRX3N pin of the video conversion unit.

3. The power bank with a docking station function according to claim 1, wherein the video conversion unit is configured to convert a DP signal from a computer into a high-definition multimedia interface (HDMI) signal, and an HDMID2P pin, an HDMID2N pin, an HDMID1P pin, an HDMID1N pin, an HDMID0P pin, and an HDMID0N pin of the video conversion unit are connected to a D2P pin, a D2N pin, a D1P pin, a D1N pin, a D0P pin, and a D0N pin of an HDMI respectively.

4. The power bank with a docking station function according to claim 1, wherein the S pin of the analog switch unit is connected to the PA6 pin of the controller through a HUB_EN terminal, the controller controls the S pin to be at the low level, a D+ pin and a D− pin of the analog switch unit are connected to an HSD1+ pin and an HSD1− pin, an HSD1+ pin and an HSD1− pin of the analog switch unit are connected to a D+ pin and a D− pin of the data conversion unit respectively through a UA1_D1_P signal terminal and a UA1_D1_N signal terminal, and the USB interface has the data transmission function.

5. The power bank with a docking station function according to claim 1, wherein the controller controls the S pin of the analog switch unit to be at the high level, a D+ pin and a D− pin of the analog switch unit are connected to an HSD2+ pin and an HSD2− pin, the D+ pin and the D− pin of the analog switch unit are connected to a D+ pin and a D− pin of a fast charging chip respectively through a UA1_P signal terminal and a UA1_N signal terminal, and the USB interface has the fast charging function.

6. The power bank with a docking station function according to claim 1, wherein an HSD0− pin and an HSD0+ pin of the data conversion unit are connected to a D− pin and a D+ pin of the Type-C main interface respectively through a HUB_D_N terminal and a HUB_D_P terminal.

7. The power bank with a docking station function according to claim 1, wherein a chip model of the controller is set to CS32G020K8U.

8. The power bank with a docking station function according to claim 1, wherein a chip model of the data conversion unit is set to VL817.

9. The power bank with a docking station function according to claim 1, wherein a chip model of the video conversion unit is set to PS176.

10. The power bank with a docking station function according to claim 1, wherein a chip model of the analog switch unit is set to FSUSB42.
